(19) United States
(12) Patent Application Publication
(10) Pub. No.: US 2014/0259145 A1
(43) Pub. Date: Sep. 11, 2014

(54) Light Weight Profiling Apparatus Distinguishes Layer 7 (HTTP) Distributed Denial of Service Attackers From Genuine Clients

(71) Applicant: Barracuda Networks, Inc., Campbell, CA (US)

(72) Inventors: Neeraj Khandelwal, Koramangala (IN); Chandra Sekar Inguva Venkata, Koramangala (IN); Anirudha Kamatgi, Koramangala (IN); Chandradip Bhattacharya, Koramangala (IN)

(21) Appl. No.: 13/955,428

(22) Filed: Jul. 31, 2013

Related U.S. Application Data
(60) Provisional application No. 61/775,142, filed on Mar. 8, 2013.

(51) Int. Cl. H04L 29/06

(52) U.S. Cl. CPC H04L 63/1458; H04L 63/0227
USPC 726/13; 726/22

(57) ABSTRACT

An apparatus discerns clients by the requests made to a web application server through a web application firewall, which injects client side code into the responses with a randomized challenge that needs a unique answer to be returned in the cookie. The client side code generates cookies, which identify a browser to the web application server, or the web application firewall in subsequent requests if made by a normally configured browser and a fail threshold is checked for subsequent requests originating from such a browser. Each browser is thus fingerprinted and if the expected answer failures exceed a threshold, the client is marked as suspicious and a subsequent Turing test is enforced to these suspicious clients, failing which, a subsequent defined action is taken.

### RELATED APPLICATIONS

This non-provisional application claims priority from provisional application Ser. No. 61/775,142 filed 8 Mar. 2013 which is incorporated by reference in its entirety.

### BACKGROUND

The present invention concerns protection for a web application exposed to the public Internet. A conventional web application firewall apparatus or cloud based service is a reverse proxy based system installed in the path between the Internet and web servers. It is intended to protect the web server from attacks launched from the world wide area network known as the Internet. Because it is a reverse proxy, a conventional web application firewall can rewrite both ingress traffic and egress traffic.

Distributed Denial of Service (DDoS) attacks may be conducted at layer 4 and at layer 7 of a protocol stack. Layer 7 DDoS attacks target the application and session layers of the network stack rather than flooding the network layers with TCP/UDP/ICMP packets, etc. Such attacks require less attack bandwidth and resources compared to layer 4 attacks, are stealthier, and bring down the web applications and services of the victim, even though the network may still be available. These characteristics make them attractive to the attackers. Normally, such attacks are carried out by massively distributed attack nodes that have been compromised and under the control of the attackers. Such systems are commonly referred as botnets. These nodes used to be PCs, but now encompass mobile devices as well as cloud based servers.

To solve the long standing and prohibitively costly problem of layer 7 Distributed Denial of Service attacks on web application servers, it would be desirable to track and distinguish clients conducting a DDoS attack from genuine bursts of traffic by legitimate sources. Conventional prior art solutions did not, could not, and would not distinguish from legitimate human users and automated attackers without being expensive or causing potential break of seamless access to the applications from such legitimate users. The blind imposure of Turing tests might (a) break client accesses to the applications via methods like POST (b) force genuine users to go through an extra step before getting an access to the application, and c) be cost ineffective since the Turing tests are expensive with respect to the resources needed on any apparatus. So a way to fingerprint and discern suspicious clients before imposing Turing tests to distinguish between scripts controlling browsers (or automated scripts directly sending requests) from humans operating browsers is needed.

### BRIEF DESCRIPTION OF DRAWINGS

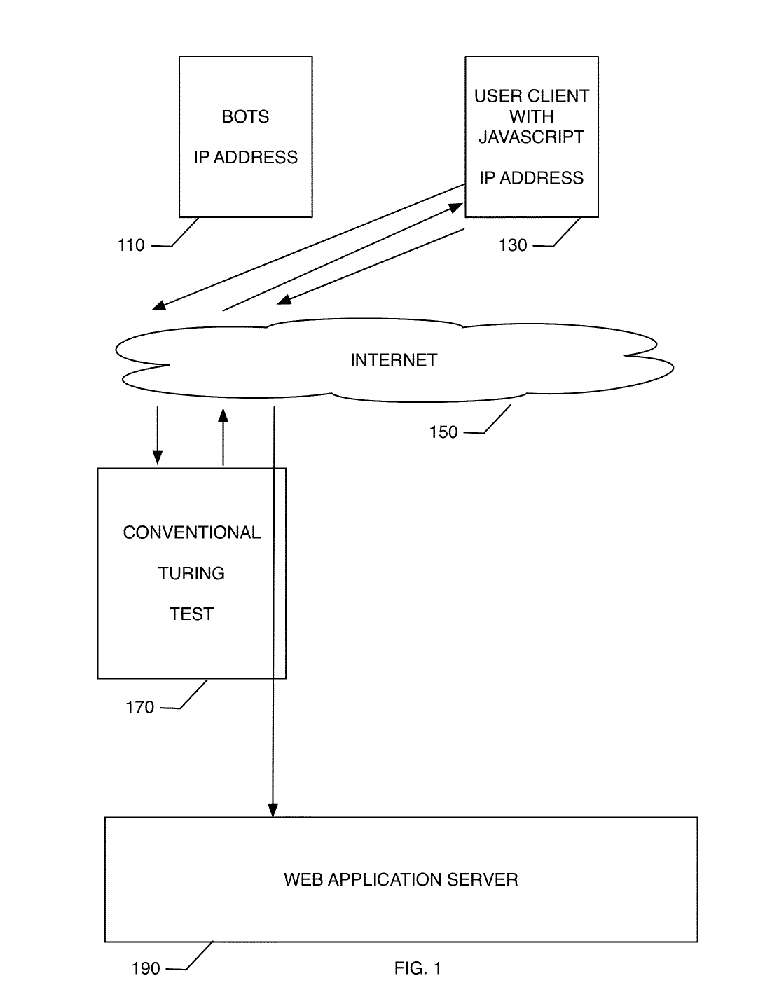

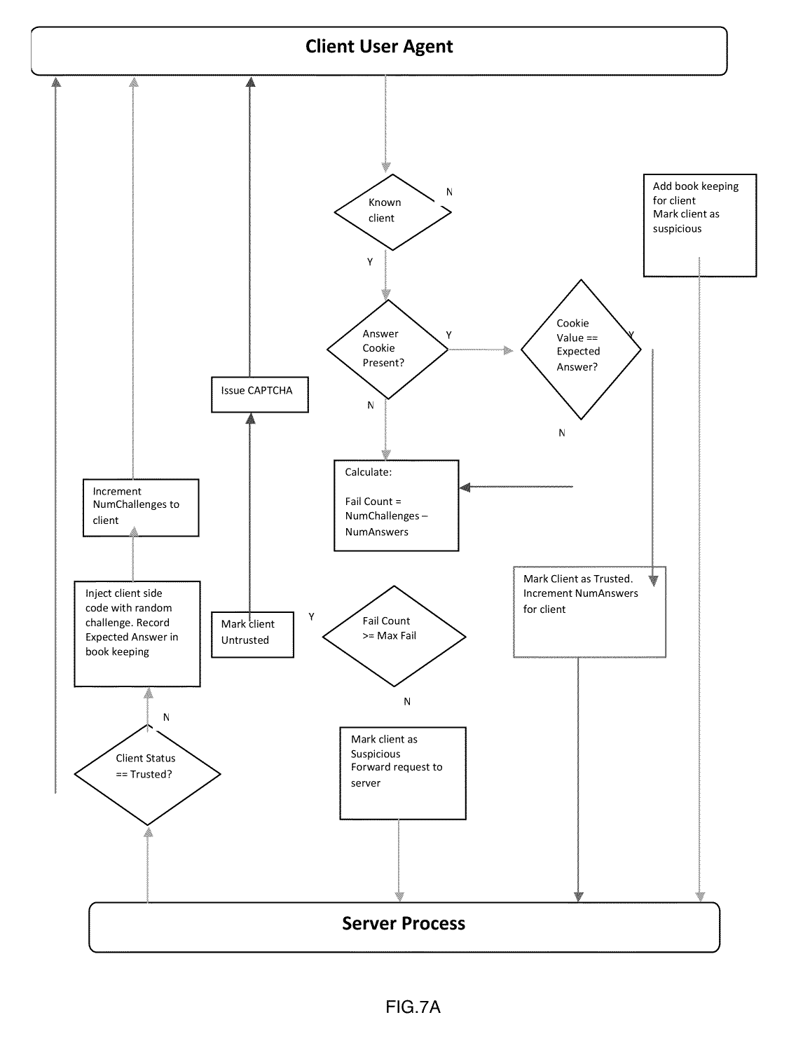

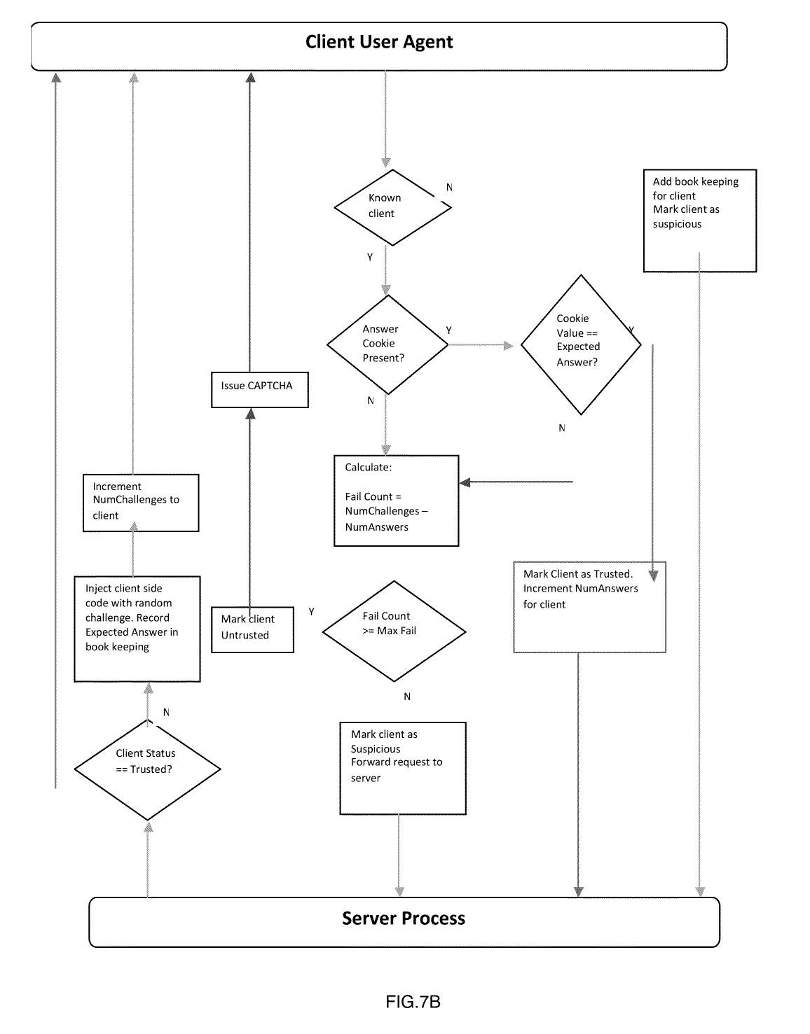

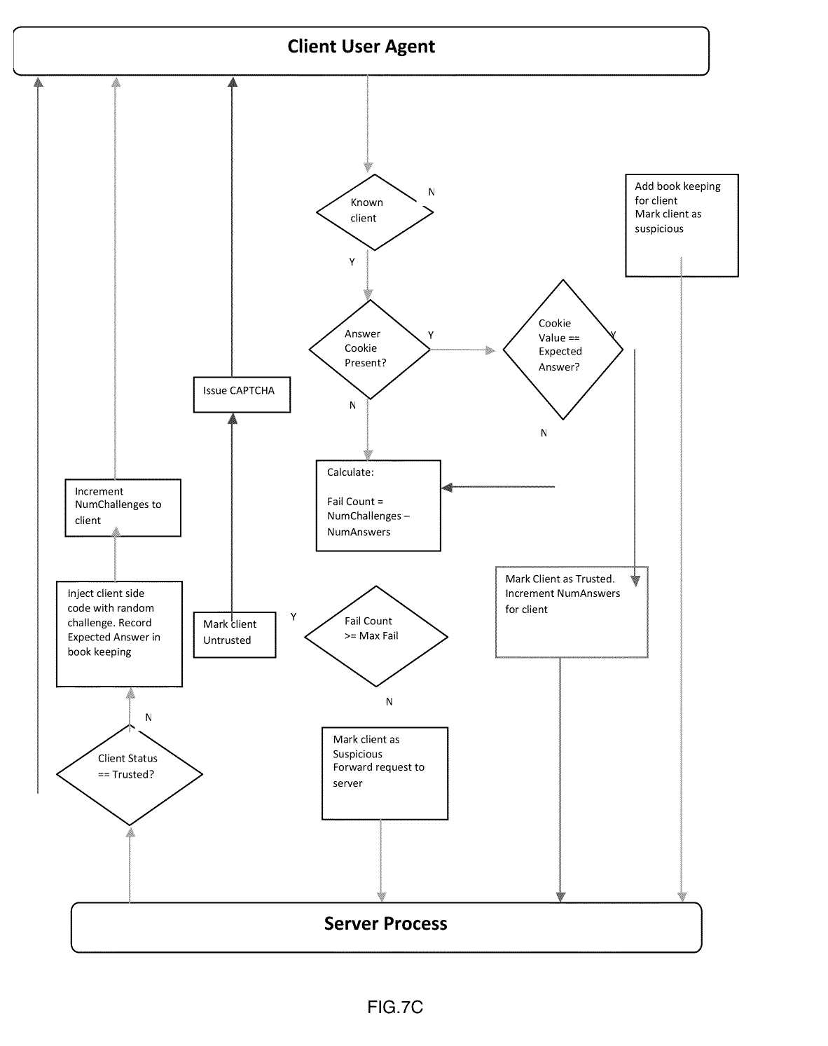

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which: FIG. 1-6 is a dataflow diagram between user clients and an application server. FIGS. 7A,B,C is a flowchart of a method of operation.

### SUMMARY OF THE INVENTION

The apparatus receives client requests, obtains a response from a web server and injects client side code before forwarding the response to the client. In an embodiment, the genuine response is augmented with instructions containing a randomized challenge and forwarded on to the requesting client. One mechanism is to embed JavaScript instructions to inject cookie with a randomized challenge answer which uniquely identify the source of requests. An improved web application firewall then marks a client as suspicious if the number of failures from the client to return the expected randomized answer exceeds a specified failure threshold. Upon such a trigger, the client will be further challenged with Turing tests (e.g. CAPTCHA, an initialism for “Completely Automated Public Turing test to tell Computers and Humans Apart”, a trademark of Carnegie Mellon University) before they could access the resource intensive backend application entities. DETAILED DISCLOSURE OF EMBODIMENTS

An improved web application firewall comprises a circuit to inject executable code with a randomized challenge into responses to requests from external clients. The executable code once received by a browser, executes the challenge code to generate traceable cookies with the expected answer with each subsequent request. The improved web application firewall then monitors and measures the delivery of cookies from clients which have previously received the executable code, based on the arrival rate of cookies, and the presence and the correctness of the cookie's value, deciding to accepting or challenge further traffic from a source with a Turing test.

In an embodiment, when a http request comes in from a client who is not yet discerned to be a genuine user agent or a crawler or a compromised bot, the engine within the device (WAF) creates a book keeping entity against the IP address of the client and forwards the request to the backend application without breaking the client's access to the application right away. The response received from the backend application is then modified to include a script which is executable on the client endpoint, with an algorithm which needs computation by JavaScript execution on the client side. A random number is used as a salt and the script is constructed in a way to be able to compute the result of a logical operation with the salt and the IP address of the client, which results in a unique answer/result. This result is stored in the entity created against the IP of the client. A counter is then incremented against the client to record the fact that such an answer is expected from the client on subsequent requests. The script is constructed in a way so as to return the result in a cookie for subsequent requests. The fundamental assumption here is a genuine client browser, would be able to execute this script and compute the expected answer and return in the cookie set by the injected code.

When a subsequent request comes in from the same client IP, the engine looks for the expected cookie. The following scenarios are possible:

(a) The expected answer cookie is not found in the request—in which case the difference between the number of challenges given and the number of answers returned will be checked against a user configured fail threshold. If the fail threshold is exceeded (which means the client did not come back with answers keeping in pace with the challenges given out) the client will be deemed suspicious and for a subsequent request from the client, a CAPTCHA will be issued and the client will be forced to answer that before accessing the resource intensive entity on the backend application. This is usually the case with a busy botnet.

If the counters do not exceed fail threshold, the request will be forwarded to the backend and responses will continue to be injected with code and the counters for challenges issued will be incremented against the specific client IP entity.

(b) The expected answer cookie is found in a subsequent request, but the value does not match with the result recorded in the book keep entry for this client IP: in which case, a counter for the number of Challenge failures is incremented against the client IP. Once the difference between successful answers and challenge failures exceeds the fail threshold, the client will be deemed suspicious and the client will be forced to answer that before accessing the resource intensive entity on the backend application. If the counters do not exceed fail threshold, the request will be forwarded to the backend and responses will continue to be injected with code and the counters for challenges issued will be incremented against the specific client IP entity.

c) The expected answer cookie is found in a subsequent request, and the value does match with the result recorded in the book keep entry for this client IP: in which case the client is not deemed to be suspicious and allowed to access the resource intensive entity on the backend. The counter for successful answers in incremented for a future inspection in case the client fails to answer the cookies (to tolerate it for a greater fail threshold). This is usually the case with a burst of genuinely enthusiastic clients.

The situations described above, ensures that crawlers and busy botnets will soon exceed failure thresholds and will be challenged with turing tests while any genuine activity goes on seamlessly without getting bothered with expensive Turing tests (which involve image generations and are thus memory and CPU intensive).

Accesses to a publicly disclosed web application can come from public IPs which are assigned to a block of user agents., and the above algorithm with fail threshold, ensures that a user agent accessing from the same public IP as a crawler or suspicious client, is penalized and this ensures more efficient protection against DDOS where the attacks are orchestrated from a block of machines which are compromised in a specific organization.

In one embodiment, a failure threshold of 128 is a recommended setting for many of the applications and the client access patterns. The scope of the invention relates to applications which generate hypertext markup language for presentation in a browser. Both JavaScript and cookie support or their equivalents are essential for the clients to access the web application seamlessly. Users who have turned off either will be invited to turn them on in order to be able to access the protected application or may given a direct path to a Turing test.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

Referring to FIG. 1, one or more attacking bots are shown 110 among one or more user clients 130 with javascript enabled. All are communicatively coupled through a public wide area network such as that known as the Internet 150. A conventional Turing test apparatus 170 is deployed to protect a web application server 190. To isolate the web application server from attackers, the conventional Turing test apparatus intercepts all initial requests to the web application server, generates a complex human readable image, transmits it to the client and evaluates the reply from the client. This process is costly in penalizing legitimate users and consuming resources.

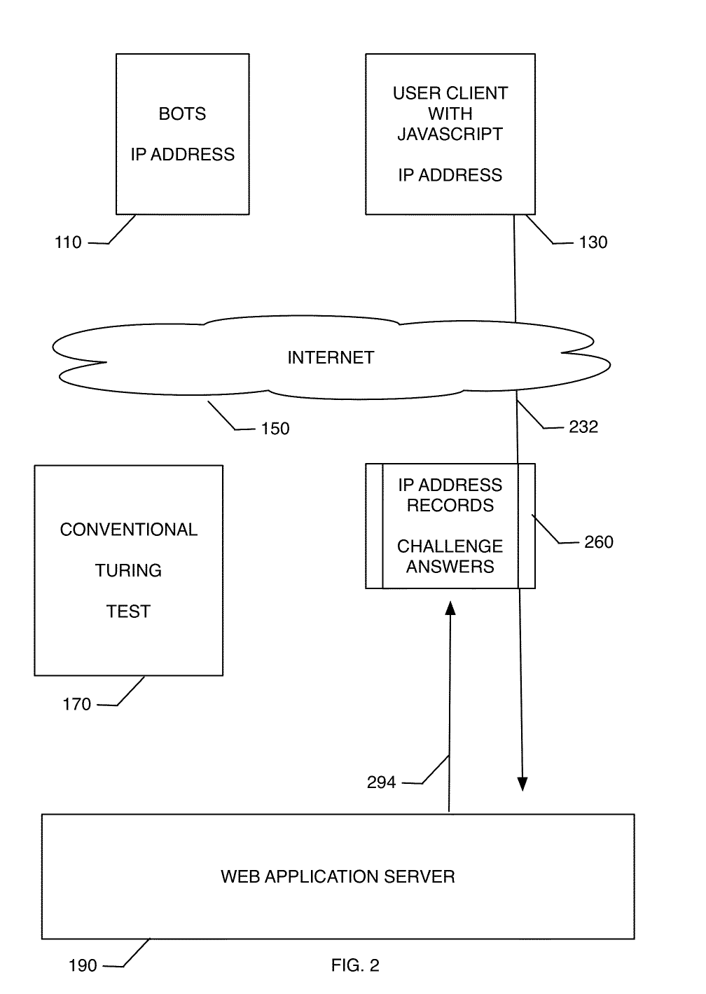

In FIG. 2, one aspect of the invention is an IP Address Record keeping store 260 which notes the IP address of a requesting client 130 when the initial request 232 is made to the web application server 190. The web application server responds to this initial request 294. The invention generates a challenge and the expected answer from the requesting user client which is stored in the IP Address Records store 260.

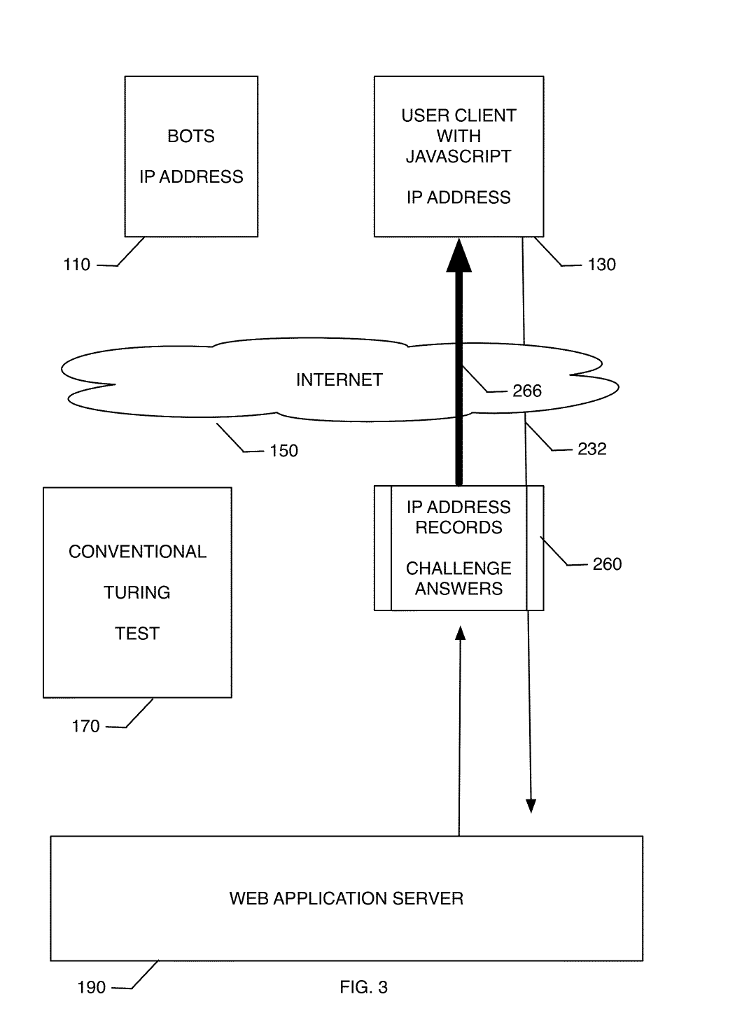

FIG. 3 shows that the response to the request is delivered with a script 266 that causes a cookie to be generated if received at a genuine user client with Javascript enabled at the IP address of the initial requestor. This cookie includes a count of the number of requests made.

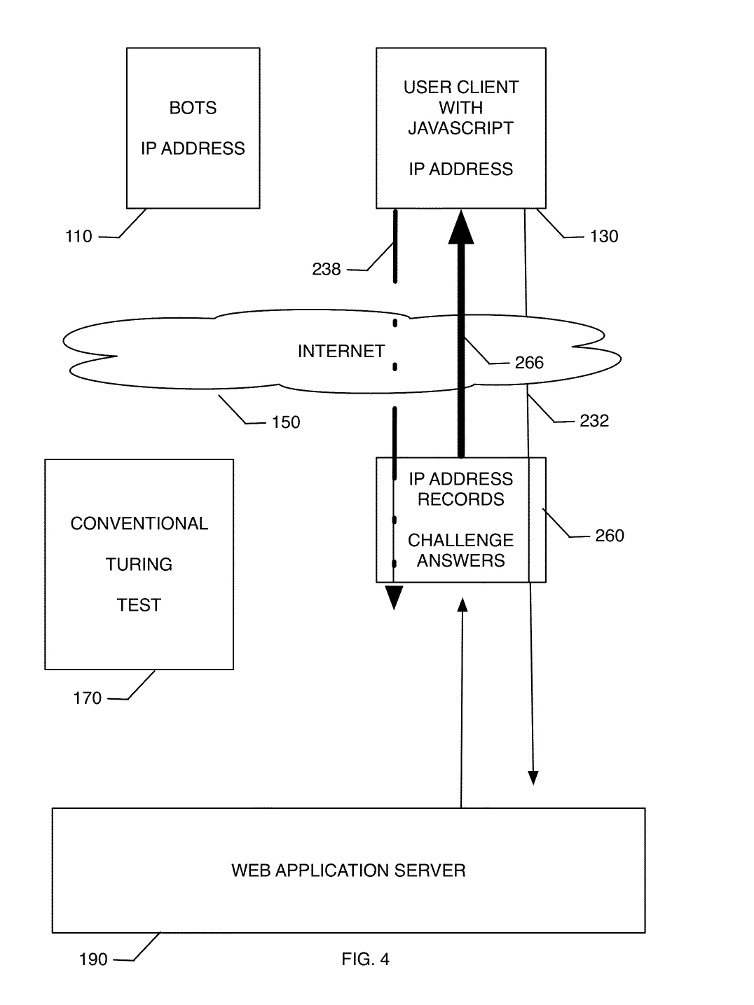

In FIG. 4 a subsequent request 238 is made from user client 130 which has a cookie attached. The cookie contains the IP address and the answer to the challenge determined execution of the Javascript at user client 130. The answer may be compared with the answer stored in the IP Address record store 260 used to determine a failing percent over a period of time.

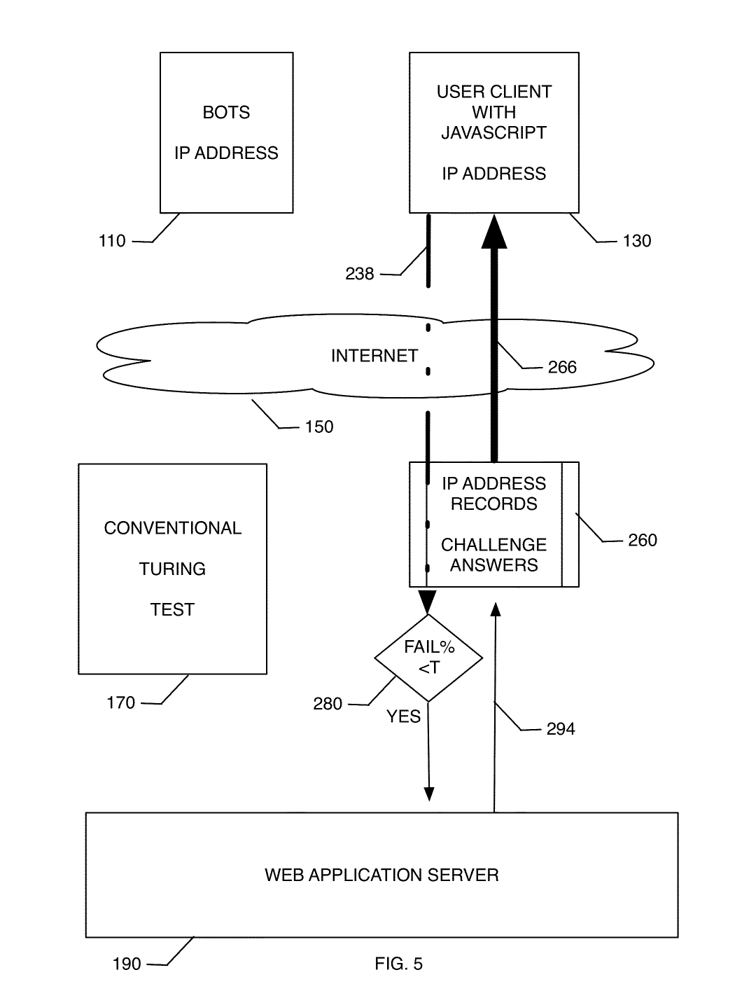

In FIG. 5 a comparison is made with a threshold of failures. As long as the number or percentage of failures in a period of time does not exceed the threshold, (which is under administrative control), the request is passed through to the web application server. Further responses 294 continue to be augmented with challenge codes and a count a maintained of the number of passes and fails. FIG. 5 illustrates the continuously successful mode of operation

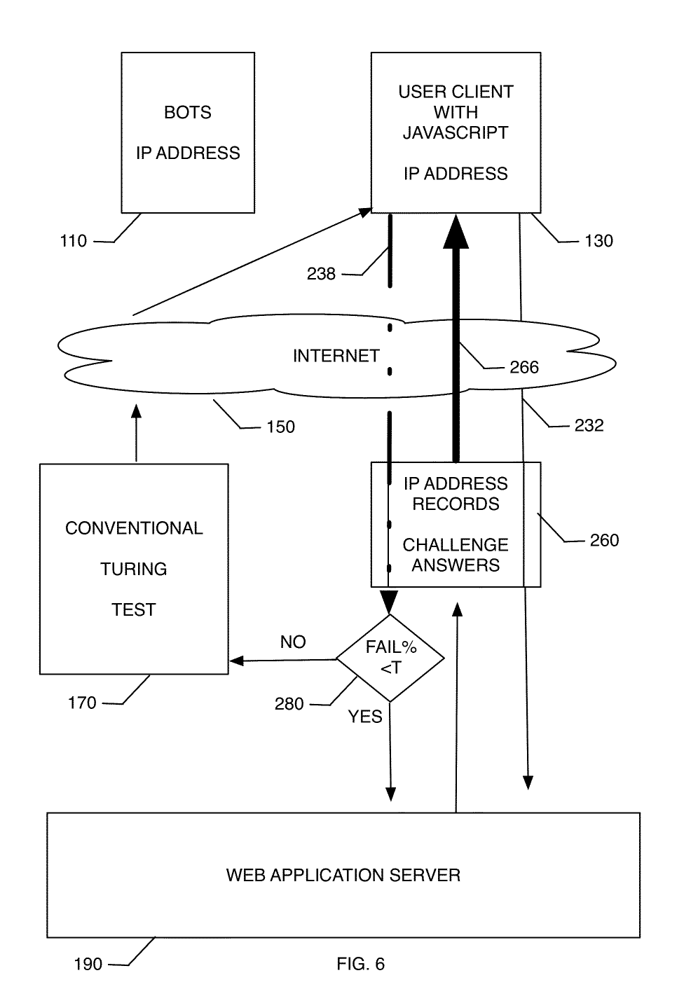

However, FIG. 6 illustrates the complete system which includes the case where the number or percent of failures within a period of time exceeds a threshold. In that case control is passed to a conventional Turing test apparatus which generate a new image and grades the user recognition of the image. Advantageously, the Javascript computation of the answer to the challenge is hidden during the users consumption of the response to the preceding request and his formulation of which request to make next.

FIG. 7 is a flow chart of the processes in the method of operating the inventive apparatus. It is understood the several of these processes may operate in parallel or overlapped in time. It is not necessary that one complete before another can initiate. They may be performed asynchronously which is an advantage of this claimed invention.

Referring now to FIG. 7A, a method of operation for a processsor coupled to network interfaces to control access from a Client User Agent 300 to a Server Process 500, the processor further coupled to a bookkeeping store 600 has the following processes: receiving a request 310 from a Client User Agent 300 at an Internet Protocol (IP) address; examining a book keeping store 600 to determine the condition that the Client User Agent(client) is a known client 320; on the condition that the client 300 is not already a known client, adding a book keeping store record for the client 320; marking a client status in book keeping store 600 as suspicious 340; forwarding the client request 350 to the Server process 500; when the Server process provides a response for a client, determining if the client status in the book keeping store 600 is trusted i.e. not suspicious; on the condition that the client status is trusted, transmitting 590 the response to the Client User Agent 300; on the condition that the client status is suspicious, injecting client side code with random challenge and recording the Expected Answer in book keeping store 570; incrementing a counter NumChallenges for this client in book keeping store 580; and

transmitting 590 the response (now enhanced with client side code) to Client User Agent 300.

Referring now to FIG. 7B, on the condition that a request is received from a known client, determining if an Answer Cookie (created by client side code) is present in the request 620; on the condition that an Answer Cookie is present, determining if the Cookie value is matched to an Expected Answer stored in book keeping store for the IP address of the Client User Agent 630; on the condition that the Cookie value is equal to the Expected Answer, marking the client status as Trusted 640; incrementing a counter NumAnswers for this client in book keeping store 650; forwarding the request to the server process 350; on either of the conditions that the answer cookie is not present or does not have the expected value, calculating a Fail Count 660 by subtracting the NumAnswers from the NumChallenges; upon determining the condition Fail Count exceeds Max Fail 670 is false, marking the client status as suspicious 680; and forwarding the request to Server Process 690.

Referring now to FIG. 7C, the method further includes the processes: upon determining the condition Fail Count exceeds Max Fail 670 is true, marking the client as Untrusted 880 in the bookkeeping store 600, and initiating a Turing test 890 to further control access by the Client User Agent 300 to the Server Process 500.

One aspect of the invention is an apparatus which includes in addition to conventional computer cooling, power, and user interface circuitry: a processor coupled to a network interface circuit communicatively coupled to a client user agent and further communicatively coupled to a server process at a server; the network interface circuit; a bookkeeping store coupled to the processor; a client side code with random challenge circuit; a first counter to record NumChallenges for a first client; a second counter to record NumAnswers for a first client; a fail count circuit to subtract NumAnswers from NumChallenges for a first client; a comparison circuit to determine if a result determined by the fail count circuit exceeds a value stored for Max Fail; and computer readable non-transitory storage devices coupled to the processor.

An other aspect of the invention is a method at a firewall apparatus to protect an application server from Distributed Denial of Service attack having the following processes receiving a response from a web application server intended for a requesting client, injecting client code for execution within the requesting client, transmitting the response with injected client code, receiving a plurality of requests for a subsequent response from the requesting client; counting the number of successful expected answers included with the request for subsequent requests, and filtering the request according to number of successful versus failed answers received over a period of time to make a decision of the need for a further Turing test before allowing access to a resource intensive entity of the application.

### CONCLUSION

The method of operation can easily be distinguished from conventional timers and image generation tests of genuine users by not penalizing them or degrading the user experience.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple communicatively coupled sites.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A method at a firewall apparatus to protect an application server from Distributed Denial of Service attack comprising:
receiving a response from a web application server intended for a requesting client,
injecting client code for execution within the requesting client,
transmitting the response with injected client code,
receiving a plurality of requests for a subsequent response from the requesting client,
counting the number of successful expected answers included with the request for subsequent requests, and
filtering the request according to number of successful versus failed answers received over a period of time to make a decision of the need for a further Turing test before allowing access to a resource intensive entity of the application.

2. A method of operation for a processsor coupled to network interfaces to control access from a Client User Agent to a Server Process, the processor further coupled to a bookkeeping store comprises:
receiving a request from a Client User Agent at an Internet Protocol (IP) address;
examining a book keeping store to determine the condition that the Client User Agent(client) is a known client;
on the condition that the client is not already a known client,
adding a book keeping store record for the client;
marking a client status in book keeping store as suspicious;
forwarding the client request to the Server process;
when the Server process provides a response for a client,
determining if the client status in the book keeping store is trusted;
on the condition that the client status is trusted,
transmitting the response to the Client User Agent;
on the condition that the client status is suspicious,
injecting client side code with random challenge into said response and recording the Expected Answer in book keeping store
incrementing a first counter NumChallenges for this client in book keeping store; and
transmitting said response (now injected with client side code with random challenge) to Client User Agent.

3. The method of claim 2 further comprising
on the condition that a request is received from a known client,
determining if an Answer Cookie (created by client side code) is present in the request from a Client User Agent
on the condition that an Answer Cookie is present, p2 determining if the Answer Cookie value is matched to an Expected Answer stored in book keeping store for the 1P address of the Client User Agent;
on the condition that the Cookie value is equal to the Expected Answer,
marking the client status as Trusted;
incrementing a second counter NumAnswers for this client in book keeping store;
forwarding the request to the server process;
on either of the conditions that the Answer Cookie is not present or does not have the Expected Answer,
calculating a Fail Count 660 by subtracting the NumAnswers from the NumChallenges;
upon determining the condition Fail Count exceeds Max Fail is false,
marking the client status as suspicious; and
forwarding the request to Server Process.

4. The method of claim 3 further comprising;
upon determining the condition Fail Count exceeds Max Fail is true,
marking the client as Untrusted in the bookkeeping store, and
initiating a Turing tes to further control access by the Client User Agent to the Server Process.

5. An apparatus comprising
a processor coupled to a network interface circuit communicatively coupled to a client user agent and further communicatively coupled to a server process at a server;
the network interface circuit;
a bookkeeping store coupled to the processor;
a client side code with random challenge circuit;
a first counter to record NumChallenges for a first client;
a second counter to record Nu Answers for a first client;
a fail count circuit to subtract NumAnswers from NumChallenges for a first client;
a comparison circuit to determine if a result determined by the fail count circuit exceeds a value stored for Max Fail; and
computer readable non-transitory storage devices coupled to the processor.
